(19) United States
(12) Patent Application Publication
(10) Pub. No.: US 2012/0061972 A1
(43) Pub. Date: Mar. 15, 2012

(54) VERTICAL-AXIS WIND TURBINE

(76) Inventor: Richard Nils Young, Atlanta, GA (US)

(21) Appl. No.: 13/148,464

(22) PCT Filed: Feb. 8, 2010
(86) PCT No.: PCT/US10/23523

§ 371 Date: Nov. 10, 2011

Related U.S. Application Data
(60) Provisional application No. 61/150,523, filed on Feb. 6, 2009.

(51) Int. Cl. F03D 9/00

(52) U.S. Cl. 290/55

(57) ABSTRACT

A vertical-axis wind turbine and methods for using the same are provided. The vertical-axis wind turbine has a substantially cylindrical rotor assembly having a lower circular frame member and a spaced upper circular frame member and a plurality of substantially vertical blades connected to and extending between the respective lower and upper frame members. At least one electrical generator having a rotative wheel is mechanically coupled to a portion of the rotor assembly. A plurality of support members are configured to rotatively support the rotor assembly about a vertical axis of the wind turbine at a spaced distance from a ground surface.

### RELATED APPLICATIONS

This application is a 35 U.S.C. §371 national phase application of International Application No. PCT/US2010/023523, filed Feb. 8, 2010, which claims priority to U.S. Provisional Application No. 61/150,523, filed Feb. 6, 2009, which are hereby incorporated herein by reference in their entireties. This application claims the benefit of all above-listed applications.

### FIELD OF THE INVENTION

This invention relates generally to a wind turbine. More particularly, vertical-axis wind turbines and methods of using same are provided for efficiently generating electrical power.

### BACKGROUND OF THE INVENTION

Windmills have been in existence for centuries and have been used to grind grains, to pump water, and, more recently, to generate electricity (such windmills are typically referred to as “wind turbines”). Wind turbines are generally either horizontal-axis wind turbines (HAWTs), or vertical-axis wind turbines (VAWTs). HAWTs are more commonly used than VAWTs. HAWTs have a horizontal main rotor shaft, which is usually positioned at the top of a tower. The vanes or blades of the HAWT extend radially outward from the rotor shaft. Typically, HAWTs must be pointed into the wind in order to operate and generate electricity. HAWTs also typically utilize a gearbox, which converts the relatively slow rotation of the blades into a quicker rotation that is more suitable to drive an electrical generator.

Despite their dominating presence in the market of large, commercial wind turbines, HAWTs have several drawbacks. HAWTs have difficulty operating near the ground, where turbulent winds are prevalent. Thus, very tall towers are typically used in HAWTs, which are difficult and expensive to transport and install. The height of HAWTs makes them obtrusively visible, making them aesthetically unappealing and often engendering opposition from citizens in areas where HAWTs are installed.

In contrast to HAWTs, VAWTs have a main rotor shaft that is vertically positioned. Thus, VAWTs do not need to be pointed into the wind in order to operate. The vertical rotor axis also allows the generator and gearbox to be positioned nearer to the ground, so that they do not have to be fully supported by the tower, as in HAWTs. VAWTs are not as affected by turbulent winds, and thus can be positioned closer to the ground than HAWTs. By being positionable closer to the ground, VAWTs can take advantage of locations where mesas, hilltops, ridgelines, and passes funnel the wind and increase wind velocity. VAWTs also have lower startup speeds than HAWTs.

On the other hand, VAWTs are less efficient than HAWTs, in large part due to the additional drag that they experience as their blades rotate into the wind. A VAWT that uses guy-wires to hold it in place puts stress on the bottom bearing as all of the weight of the rotor is on the bearing. On the other hand, guy-wires attached to the top bearing increase downward thrust into wind gusts. In order to solve this problem, superstructures have been used to hold the top bearing in place to eliminate the downward thrusts of gust events in guy wired models. While several components of VAWTs can be positioned near the ground, they are typically located under the weight of the structure above, which can make changing out components incredibly difficult without dismantling most or all of the structure.

Yet another disadvantage of VAWTs is that they typically employ a central axis drive shaft, to which all of the rotating elements are attached and by which all of the rotating elements are supported. When VAWTs having a large diameter are used, the force of the wind on the turbine blades not only produces power, but produces a large overturning moment on the central drive shaft bearings.

Thus, there is a need in the art for an efficient wind turbine that can be used in various locations, under various wind conditions, without being subjected to high stresses.

### SUMMARY OF THE INVENTION

In accordance with the purpose(s) of this invention, as embodied and broadly described herein, this invention, in one aspect, relates to a vertical-axis wind turbine. The vertical-axis wind turbine, in one aspect, comprises a rotor assembly and a plurality of support members configured to support the rotor assembly at a spaced distance from the ground. The rotor assembly, in one aspect, comprises a lower frame member and a spaced upper frame member that are connected by a plurality of blades.

In a further aspect, a power house can be positioned at a proximal end of at least one of the plurality of support members. Each power house can comprise a wheel and a generator. The wheel can be in operative communication with the rotor assembly such that the rotation of the rotor assembly causes the wheel to rotate. The wheel is in further communication with the generator, and the rotation of the wheel is translated to the generator, causing the generator to generate electrical power.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 is a perspective view of a vertical-axis wind turbine, according to one aspect.

FIG. 2A is a perspective view of a housing of the vertical-axis wind turbine of FIG. 1.

FIG. 2B is a partially transparent perspective view of the housing of FIG. 2A.

FIG. 3 is a partial perspective view of a power house of the vertical-axis wind turbine of FIG. 1.

FIG. 4 is a perspective view of the wind turbine of FIG. 1, showing a wheel and generator positioned therein a power house of the vertical-axis wind turbine.

FIG. 5A is a perspective view of a wheel and generator of the vertical-axis wind turbine of FIG. 1.

FIG. 5B is a side elevational view showing the generator of FIG. 5A.

### DESCRIPTION OF THE PREFERRED EMBODIMENTS

The present invention may be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

As used in the specification and the appended claims, the singular forms “a,” “an” and “the” include plural referents unless the context clearly dictates otherwise. Thus, for example, reference to a “blade” can include two or more such blades unless the context indicates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Reference will now be made in detail to the present preferred aspect(s) of the invention, examples of which are illustrated in the accompanying drawings. Wherever possible, the same reference numbers are used throughout the drawings to refer to the same or like parts.

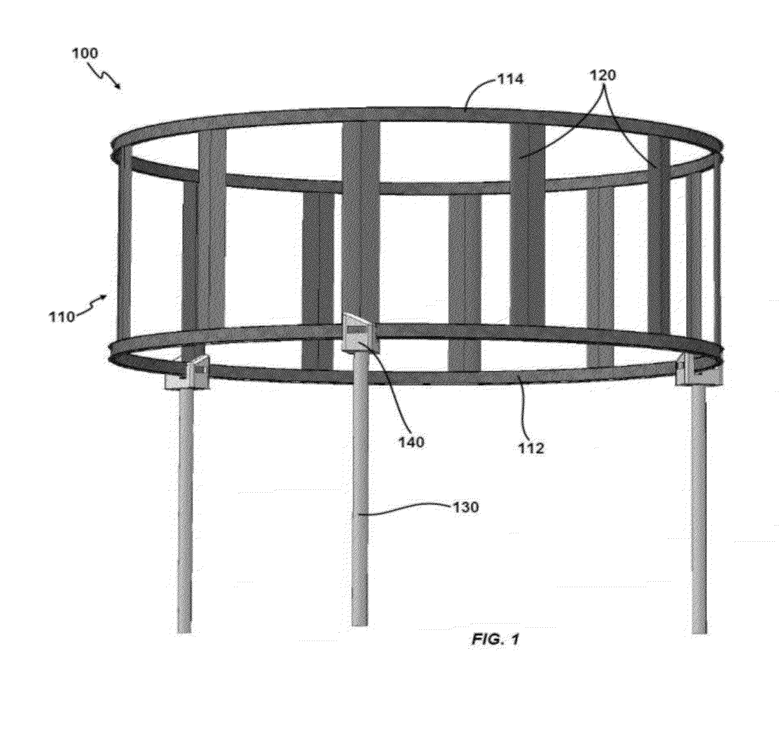

In one aspect, a vertical-axis wind turbine is provided. With reference to FIG. 1, the vertical-axis wind turbine 100, in one aspect, comprises a rotor assembly 110 having a plurality of blades 120. For example, as shown in FIG. 1, the rotor assembly can have a lower frame member 112 and a spaced upper frame member 114. The lower and upper frame members, in one aspect, can be substantially circular, and the plurality of blades can be connected to and extend between the lower and upper frame members. As illustrated, the assembled lower frame, upper frame and plurality of blades forms a substantially cylindrical structure that is structurally substantially rigid.

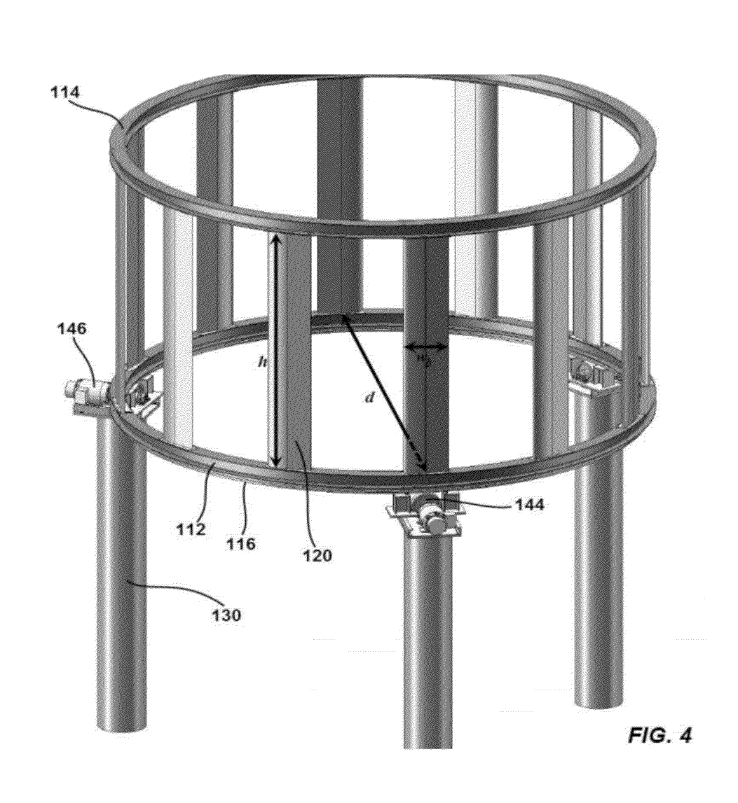

In one aspect, and not meant to be limiting, the rotor assembly can have a diameter, d, in the range of about 50 feet to about 200 feet. In another aspect, the rotor assembly can have a diameter, d, in the range of about 100 feet to about 200 feet. In one particular aspect, the rotor assembly can have a diameter, d, of approximately 175 feet (i.e., a diameter of the lower and upper frame members can be approximately 175 feet), as shown in FIG. 4. However, it is contemplated that the rotor assembly can have any diameter and is not intended to be limited to the exemplary dimensions listed above.

In one aspect, it is contemplated that the configuration of the rotor assembly can be a high solidity rotor, with a solidity being equal to total cord width/rotor diameter. In one aspect, it is contemplated that the solidity ratio's of the rotor assembly can be between about 0.5 to about 0.9, or between about 0.6 to about 0.8.

It is also contemplated that the rotor assembly can be sized so that the maximum tip speed of each blade is substantially uniform and will have a tip speed ratio of about 2. Thu, it is contemplated that the rotor tip speed would be about 2 X wind speed. For example, and without limitation, for a winds speed of about 30 MPH, the expected tip speed would be 60 MPH or 27 meters/second. Further, it is contemplated that the respective maximum G-loading on each blade will be between about 3 to 10 G.

According to one aspect, and with reference to FIG. 4, it is contemplated that each blade can have a height, h, in the range of about 40 feet to about 60 feet. In one particular aspect, each blade can have a height, h, of approximately 60 feet. However, it is contemplated that the blades can have any height, and the height is not intended to be limited to the exemplary dimensions listed above. Each blade can also have a width, w_{b}, in the range of about 5 to 10 feet. In one particular example, each blade can have a width of about 8 feet. In one aspect, it is contemplated that the swept area of the plurality of blades the rotor assembly would be sufficient to provide the contemplated relatively high solidity ratios described above.

In yet another aspect, the lower frame member 112 and the upper frame member 114 can be sized and shaped according to the selected diameter, d, of the rotor assembly, to be sufficiently stiff and minimize deflections. For example, and not meant to be limiting, if the rotor assembly has a diameter, d, of about 175 feet, each of the lower and upper frame members can be about 4 feet high and about 2 feet wide. In this example, the height, h, of the blades can be about 60 feet. Thus, the overall height of the rotor assembly can be approximately 68 feet.

According to yet another aspect, each blade can have a selected cross-sectional shape. For example, and not meant to be limiting, in one aspect, each blade can have an NACA 63₃-018 airfoil shape. However, it is contemplated that various cross-sectional or airfoil shapes can be used, such as, for example and without limitation, symmetrical or asymmetrical airfoil shapes. In another aspect, it is contemplated that the chord line of each blade can be positioned substantially tangent to the vertical axis of the wind turbine. Alternatively, it is also contemplated that each blade can be pitch relative to the tangent, i.e., the leading edge of each blade can be positioned at a greater radial distance from the vertical axis than the trailing edge of each blade. In this aspect, the chord line of each blade can be positioned or pitched at an acute angle relative to a substantially tangential position. In one aspect, it is contemplated that acute angle ranges between about 0.01 to about 5.00 degrees.

The rotor assembly can be supported by a plurality of support members 130. As can be appreciated, the plurality of support members can be configured to support the rotor assembly at a spaced distance from the ground. For example, as shown in FIG. 1, three support members can be positioned to support the rotor assembly proximate the circumference of the lower frame member 112. In yet another aspect, and as described further herein below, a rail 116 can be positioned below the lower frame member 112 of the rotor assembly, and the support members can be contemplated to support the rotor assembly proximate the circumference of the rail 116. It is contemplated, however, that any number of support members can be provided to support the rotor assembly, and is not intended to be limited to three support members as exemplarily shown in the figures. As can be appreciated, each support member can have a proximal end positioned proximate and/or directly supporting the lower frame member or the rail. Each support member can have an opposed distal end configured to support the wind turbine on a ground surface.

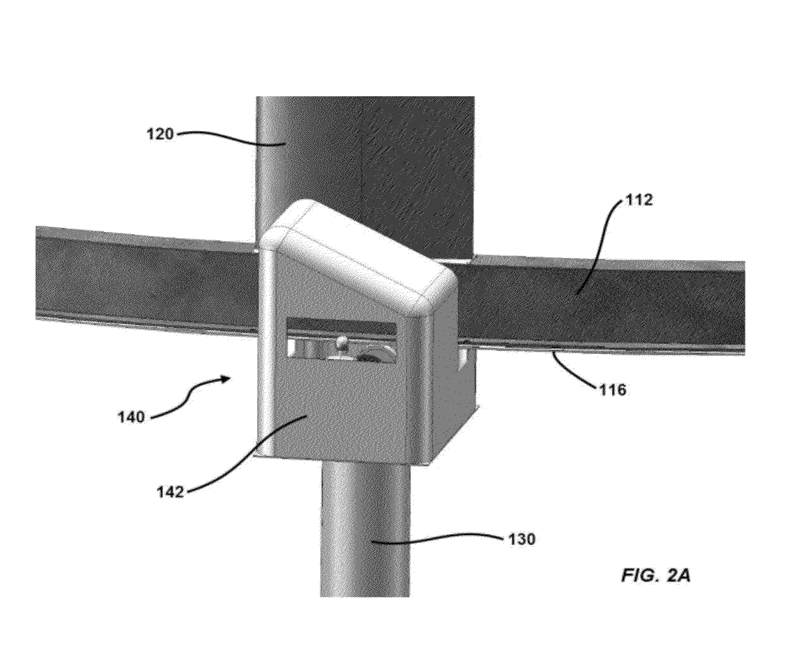

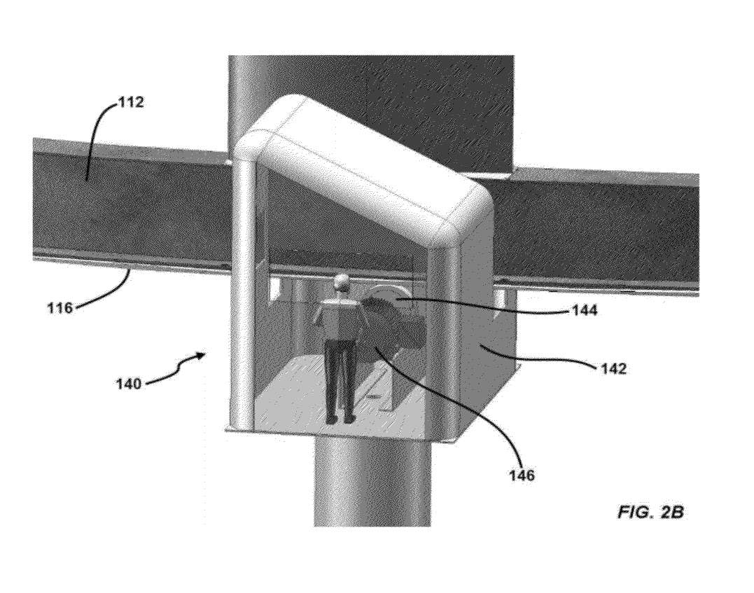

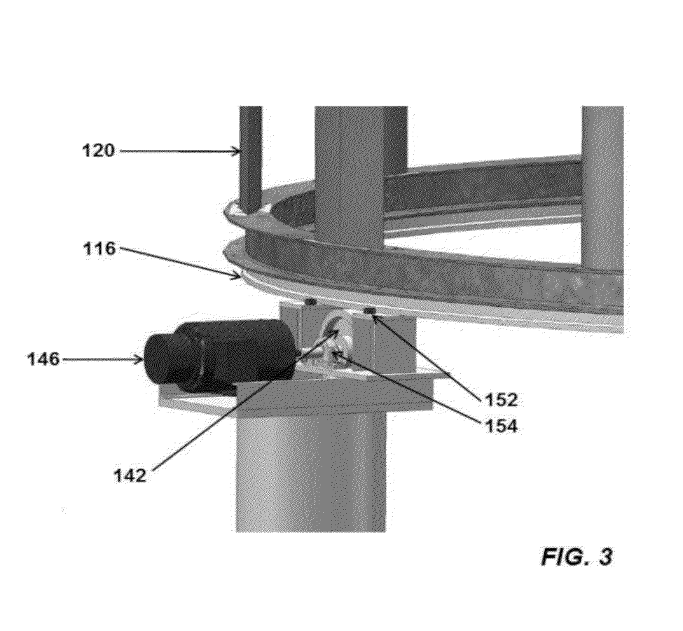

As shown in FIG. 1, in one aspect, a power house 140 is positioned at the proximal end of at least one of the support members. As shown in FIG. 2B, the power house can have a housing 142. Positioned therein each of the at least one power house can be a wheel 144 and a generator 146. In one aspect, such as shown in FIG. 3, a rail 116 can be positioned below the lower frame member 112 of the rotor assembly 110. The rail can be configured to be in operative communication with the wheel 144. One or more bearings 152 can be positioned within the power house and are configured to be in communication with the circumference or peripheral edge of the rail. As can be appreciated, as the rotor assembly rotates, the lower surface of the rail contacts the peripheral or circumferential surface of the wheel, causing the wheel to rotate. The one or more bearings 152 can assist in maintaining the rail in position as it rotates, ensuring contact with the wheel 144. For example, in one aspect, the one or more bearings 152 can constrain the circular rail horizontally and vertically as it rotates with the rotor assembly.

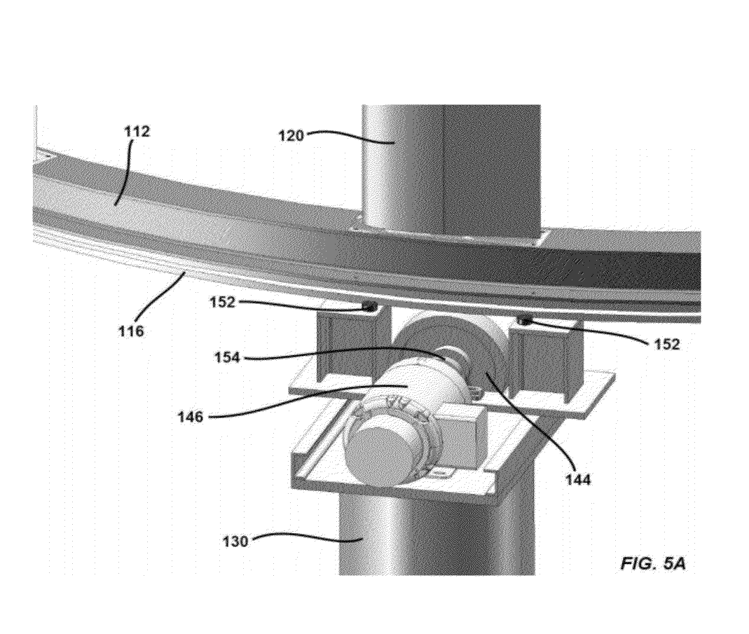

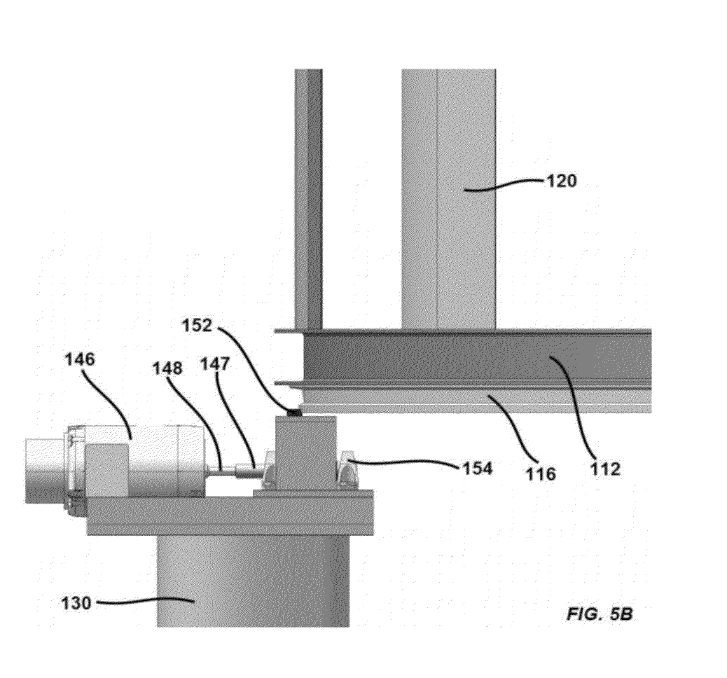

As can be seen in FIG. 5B, the wheel 144 is in operative communication with the generator 146 via a respective wheel shaft 147. More specifically, the wheel shaft can be in operative communication with a generator shaft 148. In one aspect, the wheel shaft passes through a bearing 154. As can be appreciated, as the wheel rotates, it causes the wheel shaft to rotate. The rotation of the wheel shaft, and consequently, the rotation of the generator shaft, drives the electrical generating capability of the generator. In one aspect, the wheel shaft is connected directly to the generator shaft, without the need of a gear box. However, it is contemplated that, according to another aspect, a transmission or other device can be operatively positioned therebetween the wheel shaft 147 and the generator shaft 148. Such a device could include, for example, a simple gear drive to increase or decrease the speed. Optionally a special transmission can be provided that provides a constant output speed with a variable input speed.

As described above, one or more bearings 152 can be positioned within the power house and can be configured to ensure that the rail 116 maintains contact with the wheel 144 as the rotor assembly rotates. As can be appreciated, the bearing 154 supports the wheel and carries the weight of the rotor assembly and the overturning moment of the wind load. Such a load acts as a vertical load on the one or more wheels, and is absorbed by the bearings 154. Because this load is acting at the radius of the rotor assembly, the load is far less than if it acted on bearings positioned at a central axis of the rotor assembly.

As can be appreciated, an exemplary vertical-axis wind turbine as described herein can be used to harness the power of wind to generate electric power. As the wind passes around and through the vertical-axis wind turbine 100, it exerts force on at least one blade 120 of the rotor assembly 110, and causes the rotor assembly to begin rotating. In one aspect, a power source can be provided to assist in the initial rotation of the rotor assembly, for example, if the wind power is not sufficient to initiate the rotation of the rotor assembly. As the rotor assembly begins rotating, the power source can be turned off and the rotor assembly can continue rotating under only the force of the wind. It is contemplated that at least one electrical generator can be selectively actuated to effect initial rotative movement of the rotor assembly relative to the at least one power house.

As described above, the rotation of the rotor assembly is translated to the wheel 144 in each of the at least one power houses 140 of the wind turbine. As the wheel(s) turns, it turns the wheel shaft 147, which is connected to the generator shaft 148 of the generator 146 and causes the generator to begin generating electrical power.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A vertical-axis wind turbine, comprising:
a rotor assembly comprising:
a lower circular frame member and a spaced upper circular frame member; and
a plurality of blades connected to and extending between the respective lower and upper frame members, wherein each blade is positioned substantially vertical;
a plurality of support members configured to rotatively support the rotor assembly about a vertical axis of the wind turbine at a spaced distance from a ground surface; and
at least one electrical generator having a rotative wheel that is mechanically coupled to a portion of the rotor assembly, wherein each electrical generator is fixedly coupled to a support member.

2. The vertical-axis wind turbine of claim 1, wherein the rotor assembly further comprises a circular rail mounted to and extending downwardly therefrom a bottom surface of the lower frame member.

3. The vertical-axis wind turbine of claim 2, wherein the rotative wheel of each electrical generator is operatively coupled to a portion of the circular rail such that rotation of the rail effects complementary rotation of the wheel for generation of electrical energy within the electrical generator.

4. The vertical-axis wind turbine of claim 3, further comprising at least one power house, wherein one power house is mounted on a proximal portion of a respective support member, and wherein one electrical generator is mounted therein each power house.

5. The vertical-axis wind turbine of claim 4, wherein each at least one power house has a plurality of bearings mounted thereon that are configured to rotatably support a portion of the rail such that a wind contacting the plurality of blades is operative to rotate the rotor assembly about the vertical axis of the wind turbine and relative to the at least one power house.

6. The vertical-axis wind turbine of claim 5, wherein the plurality of bearings are configured to constrain the circular rail horizontally and vertically as the rotor assembly rotates about the vertical axis of the wind turbine and relative to the at least one power house.

7. The vertical-axis wind turbine of claim 5, further comprising means for selectively actuating at least one electrical generator to effect initial rotative movement of the rotor assembly relative to the at least one power house.

8. The vertical-axis wind turbine of claim 3, wherein the plurality of support members rotatively support the rotor assembly proximate the circumference of the rail.

9. The vertical-axis wind turbine of claim 1, wherein each blade has a selected cross-sectional airfoil shape.

10. The vertical-axis wind turbine of claim 9, wherein each blade can have an NACA 63₃-018 airfoil shape.

11. The vertical-axis wind turbine of claim 9, wherein each blade has a symmetrical airfoil shape.

12. The vertical-axis wind turbine of claim 9, wherein each blade has an asymmetrical airfoil shape.

13. The vertical-axis wind turbine of claim 1, wherein a chord line of each blade is positioned substantially tangential to the vertical axis of the wind turbine.

14. The vertical-axis wind turbine of claim 1, wherein a leading edge of each blade is positioned at a greater radial distance from the vertical axis then a trailing edge of each blade such that a chord line of each blade is positioned at an acute angle relative to a substantially tangential position, and wherein the acute angle is between about 0.01 to 5.00 degrees.

15. A vertical-axis wind turbine, comprising:
a plurality of support members;
a plurality of power houses, wherein each power house is mounted on a proximal portion of a respective support member, and wherein each power house comprises an electrical generator operatively coupled to a rotative wheel, and
a substantially cylindrical rotor assembly comprising:
a lower circular frame member and a spaced upper circular frame member; and
a plurality of blades connected to and extending between the respective lower and upper frame members, wherein each blade is positioned substantially vertical,
wherein the respective plurality of power houses and support members are configured to rotatively support the rotor assembly about a vertical axis of the wind turbine at a spaced distance from a ground surface, and wherein the rotative wheel of each power house is mechanically coupled to a portion of the rotor assembly.

16. The vertical-axis wind turbine of claim 15, wherein the rotor assembly further comprises a circular rail mounted to and extending downwardly therefrom a bottom surface of the lower frame member.

17. The vertical-axis wind turbine of claim 16, wherein the rotative wheel of each electrical generator is operatively coupled to a portion of the circular rail such that rotation of the rail effects complementary rotation of the wheel for generation of electrical energy within the electrical generator.

18. The vertical-axis wind turbine of claim 15, further comprising means for selectively actuating at least one electrical generator to effect initial rotative movement of the rotor assembly relative to the plurality of power houses.

19. The vertical-axis wind turbine of claim 15, wherein each blade has a selected cross-sectional airfoil shape.

20. The vertical-axis wind turbine of claim 19, wherein each blade can have an NACA 63₃-018 airfoil shape.

21. The vertical-axis wind turbine of claim 19, wherein each blade has a symmetrical airfoil shape.

22. The vertical-axis wind turbine of claim 19, wherein each blade has an asymmetrical airfoil shape.
